(19) United States
(12) Patent Application Publication
(10) Pub. No.: US 2021/0168257 A1
(43) Pub. Date: Jun. 3, 2021

(54) NON-TRANSITORY COMPUTER-READABLE STORAGE MEDIUM STORING PROGRAM, CONTROL METHOD FOR INFORMATION PROCESSING APPARATUS, AND IMAGE PROCESSING SYSTEM

(71) Applicant: SEIKO EPSON CORPORATION, Tokyo (JP)

(72) Inventor: Yukihiro CHIKUNI, Matsumoto (JP)

(21) Appl. No.: 17/107,988

(22) Filed: Dec. 1, 2020

(30) Foreign Application Priority Data
Dec. 3, 2019 (JP) 2019-218613

(51) Int. Cl. H04N 1/00

(52) U.S. Cl. CPC H04N 1/00962; H04N 2201/0094; H04N 1/00403; H04N 1/00244

(57) ABSTRACT

A program causing a computer configuring an information processing apparatus performing communication with an image processing apparatus to realize a first function of acquiring an instruction for image processing and identification information for identifying a user based on an operation input using voice performed on the information processing apparatus by the user, a second function of determining a setting for the image processing corresponding to the acquired identification information based on correspondence information in which the identification information is correlated with the setting for the image processing, and a third function of requesting the image processing to the image processing apparatus based on the determined setting for the image processing and the acquired instruction for the image processing.

The present application is based on, and claims priority from JP Application Serial Number 2019-218613, filed Dec. 3, 2019, the disclosure of which is hereby incorporated by reference herein in its entirety.

### BACKGROUND

### 1. Technical Field

The present disclosure relates to a non-transitory computer-readable storage medium storing a program, a control method for an information processing apparatus, and an image processing system.

### 2. Related Art

In the related art, a device such as a smartphone has been operated by a specific user. In recent years, such a device may have been shared by different users. There is a situation in which a plurality of users share the same print apparatus as in a case where a common print apparatus is used by a device shared by a plurality of users.

In an information processing apparatus described in JP-A-2019-046103, when voice is input, print settings for a print apparatus are designated, or stored unique printing settings are used (refer to JP-A-2019-046103). As described above, JP-A-2019-046103 discloses a configuration of performing print settings at the time of voice input. JP-A-2019-046103 also discloses that predetermined print settings are registered in advance (refer to JP-A-2019-046103).

However, in the technique disclosed in JP-A-2019-046103, although the print settings are disclosed, print settings when a plurality of users share a print apparatus to perform printing are not disclosed. For example, when the technique disclosed in JP-A-2019-046103 is used, in a case where it is desired to set different print settings for respective users in a device shared by a plurality of users, it is necessary to input a print setting for each user every time, and thus time and effort of a user are required.

### SUMMARY

In order to solve the problem, according to an aspect, there is provided a non-transitory computer-readable storage medium storing a program executed in a computer configuring an information processing apparatus performing communication with an image processing apparatus, the program causing the computer to acquire an instruction for image processing and identification information for identifying a user based on an operation input using voice performed on the information processing apparatus by the user; determine a setting for the image processing corresponding to the acquired identification information based on correspondence information in which the identification information is correlated with the setting for the image processing; and request the image processing to the image processing apparatus based on the determined setting for the image processing and the acquired instruction for the image processing.

In order to solve the problem, according to another aspect, there is provided a control method for an information processing apparatus communicating with an image processing apparatus, the control method including acquiring an instruction for image processing and identification information for identifying a user based on an operation input using voice performed by the user; determining a setting for the image processing corresponding to the acquired identification information based on correspondence information in which the identification information is correlated with the setting for the image processing; and requesting the image processing to the image processing apparatus based on the determined setting for the image processing and the acquired instruction for the image processing.

In order to solve the problem, according to still another aspect, there is provided an image processing system including an information processing apparatus; and an image processing apparatus, in which the information processing apparatus includes an acquisition section configured to acquire an instruction for image processing and identification information for identifying a user based on an operation input using voice performed by the user, a storage section configured to store correspondence information in which the identification information is correlated with a setting for the image processing, an image processing setting controller configured to determine the setting for the image processing corresponding to the identification information acquired by the acquisition section, based on the correspondence information stored in the storage section, and an image processing request portion configured to request the image processing to the image processing apparatus based on the setting for the image processing determined by the image processing setting controller and the instruction for the image processing acquired by the acquisition section, and the image processing apparatus includes a request reception portion configured to receive the request for the image processing from the information processing apparatus, and an image processing section configured to execute the image processing based on the request received by the request reception portion.

### BRIEF DESCRIPTION OF THE DRAWINGS

FIG. 1 is a diagram illustrating a schematic configuration of an image processing system.

FIG. 2 is a diagram illustrating a configuration of functional blocks of an information processing apparatus.

FIG. 3 is a diagram illustrating a configuration of functional blocks of an image processing apparatus.

FIG. 4 is a diagram illustrating a configuration of functional blocks of a voice recognition server.

FIG. 5 is a diagram illustrating an example of correspondence information.

FIG. 6 is a diagram illustrating a sequence of processes performed in the image processing system.

FIG. 7 is a diagram illustrating a configuration of functional blocks of the information processing apparatus.

### DESCRIPTION OF EXEMPLARY EMBODIMENTS

Hereinafter, embodiments will be described with reference to the drawings.

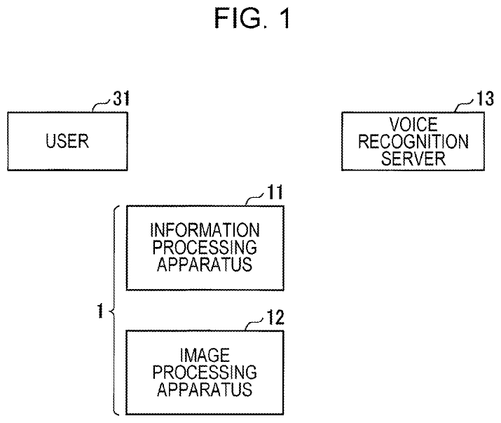

FIG. 1 is a diagram illustrating a schematic configuration of an image processing system 1 according to the embodiment. The image processing system 1 includes an information processing apparatus 11 and an image processing apparatus 12. FIG. 1 illustrates a user 31 of the information processing apparatus 11 and a voice recognition server 13. The image processing system 1 may include the voice recognition server 13.

The information processing apparatus 11 can perform communication with each of the image processing apparatus 12 and the voice recognition server 13. The information processing apparatus 11 can directly access each of the image processing apparatus 12 and the voice recognition server 13. The information processing apparatus 11 and the image processing apparatus 12 are coupled to each other in a wired or wireless manner, and perform communication with each other. Similarly, the information processing apparatus 11 and the voice recognition server 13 are coupled to each other in a wired or wireless manner, and perform communication with each other. The information processing apparatus 11, the image processing apparatus 12, and the voice recognition server 13 may be coupled to each other via the same network. The network may be the Internet, for example. Further, the image processing apparatus 12 and the voice recognition server 13 may be capable of communicating by wire or wirelessly.

The information processing apparatus 11 is a smart speaker that supports interactive voice operations. The information processing apparatus 11 may be other apparatuses, and may be any computer such as a smartphone, a tablet terminal apparatus, or a personal computer. The voice recognition server 13 is a computer. The voice recognition server 13 may be a server that can be generally used via the Internet. The image processing apparatus 12 may be a print apparatus that performs printing on paper or a scanner that reads an original document. The image processing apparatus 12 may be a multifunction peripheral including a print apparatus and a scanner.

Here, a case where print processing used as image processing will be described. The image processing apparatus 12 is a print apparatus, and settings for the image processing are settings for the print processing. The information processing apparatus 11 and the image processing apparatus 12 may be shared by a plurality of different users including the user 31. The image processing apparatus 12 may be shared by a plurality of information processing apparatuses including the information processing apparatus 11. The image processing is not limited to print processing, and may be applied to image reading using a scanner, copying using a copy function, or the like.

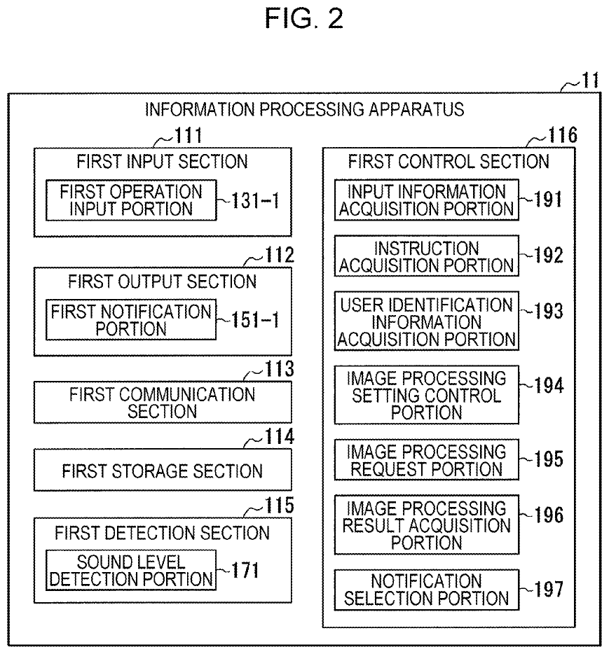

FIG. 2 is a diagram illustrating a configuration of functional blocks of the information processing apparatus 11 according to the embodiment. The information processing apparatus 11 includes a first input section 111, a first output section 112, a first communication section 113, a first storage section 114, a first detection section 115, and a first control section 116. The first input section 111 includes a first operation input portion 131-1. The first output section 112 includes a first notification portion 151-1. The first detection section 115 includes a sound level detection portion 171. The first control section 116 includes an input information acquisition portion 191, an instruction acquisition portion 192, a user identification information acquisition portion 193, an image processing setting control portion 194, an image processing request portion 195, and an image processing result acquisition portion 196, and a notification selection portion 197.

The information processing apparatus 11 performs various processes as a result of a central processing unit (CPU) executing predetermined programs stored in the first storage section 114. Such programs include an application program for controlling image processing performed by the image processing apparatus 12 and an application program for controlling image processing settings related to the image processing. These programs may be separate programs or may be configured as an integrated program. These programs are installed in the information processing apparatus 11 in advance or at any timing.

The first input section 111 is an input interface that inputs various kinds of information. The first operation input portion 131-1 receives an operation input by using voice. The first operation input portion 131-1 has a microphone, and receives information indicating the voice output from the user 31. In this case, the content of the voice is converted into the content of an operation. Here, the microphone that acquires voice is integrated with the information processing apparatus 11, but, in another example, the microphone may be provided outside the information processing apparatus 11 instead of being provided in the information processing apparatus 11. In this case, the first operation input portion 131-1 receives an operation input by using the microphone provided outside the information processing apparatus 11.

The first output section 112 is an output interface that outputs various types of information. The first notification portion 151-1 performs a notification by using voice. The first notification portion 151-1 has a speaker, and performs a notification of a notification content by outputting voice indicating the notification content from the speaker. Here, the speaker that outputs voice is integrated with the information processing apparatus 11, but, in another example, the speaker may be provided outside the information processing apparatus 11 instead of being provided in the information processing apparatus 11. In this case, the first notification portion 151-1 performs a notification by using the speaker provided outside the information processing apparatus 11.

The first communication section 113 is an interface that performs communication with other apparatuses. The first storage section 114 is a memory that stores various types of information. The first detection section 115 is a sensor that detects various types of information. The sound level detection portion 171 detects a sound level.

The first control section 116 is a controller including a processor and the like and performing various types of control. The input information acquisition portion 191 acquires information that is input by the first input section 111. The input information acquisition portion 191 acquires information regarding an operation input that is received by the first operation input portion 131-1. The instruction acquisition portion 192 receives an instruction based on information acquired by the input information acquisition portion 191. The instruction is an instruction related to image processing. The instruction acquisition portion 192 exchanges information with the voice recognition server 13 as necessary.

The user identification information acquisition portion 193 acquires identification information of the user 31. The first operation input portion 131-1 receives information indicating voice that is output from the user 31 as an operation input. The user identification information acquisition portion 193 acquires information for identifying the user 31 based on the voice. The user identification information acquisition portion 193 exchanges information with the voice recognition server 13 as necessary.

Here, the instruction acquisition portion 192 and the user identification information acquisition portion 193 are described as separate constituents, but they may be integrated with each other.

The image processing setting control portion 194 controls the setting of image processing. The image processing setting control portion 194 performs control related to settings for image processing based on a result of the identification of the user 31 performed by the user identification information acquisition portion 193. The image processing setting control portion 194 may perform control related to settings for image processing based on still other information. The image processing setting control portion 194 performs a process of determining setting content for image processing, a process of performing setting such that the setting content are to be used, a process of deleting the setting content, and a process of changing the setting content.

The setting content for the image processing are stored in the first storage section 114. A change history of the setting content for the image processing may be stored in the first storage section 114. The past period to which the information stored as the change history belongs may be freely selected, and a period such as one week or one month may be used. The image processing setting control portion 194 may change the setting content for the image processing based on information that is input by the first input section 111. The information may be information based on an operation input performed by the user 31, or may be information that is input from a predetermined apparatus. The image processing setting control portion 194 may change the setting content for the image processing when an instruction specified by the information that is input by the first input section 111 includes an instruction for changing the setting content for the image processing.

The image processing setting control portion 194 may change the setting content for the image processing based on the change history of the setting content for the image processing. The image processing setting control portion 194 changes the setting content for the image processing to a setting content that is set the most in the change history, a setting content that is set most frequently in the change history, or the previous setting content in the change history based on the change history of the setting content for the image processing. As a timing for the change, any timing may be set, a timing at which a predetermined instruction is performed to the information processing apparatus 11 from the user 31, or a timing designated in advance for the information processing apparatus 11 by the user 31, or a regular timing may be used.

The image processing request portion 195 requests image processing to the image processing apparatus 12 based on an instruction acquired by the instruction acquisition portion 192 and a setting content for image processing controlled by the image processing setting control portion 194. The image processing request portion 195 transmits the instruction and the setting content to the image processing apparatus 12 via the first communication section 113. The image processing result acquisition portion 196 acquires information regarding the result of the image processing performed by the image processing apparatus 12. The result of the image processing may include not only a final result of the image processing but also a result in the middle of the image processing.

The notification selection portion 197 selects an aspect of performing a notification. A notification aspect related to the image processing may be included in an image processing setting. In this case, the notification selection portion 197 may be controlled by the image processing setting control portion 194. The notification selection portion 197 may be integrated with the image processing setting control portion 194.

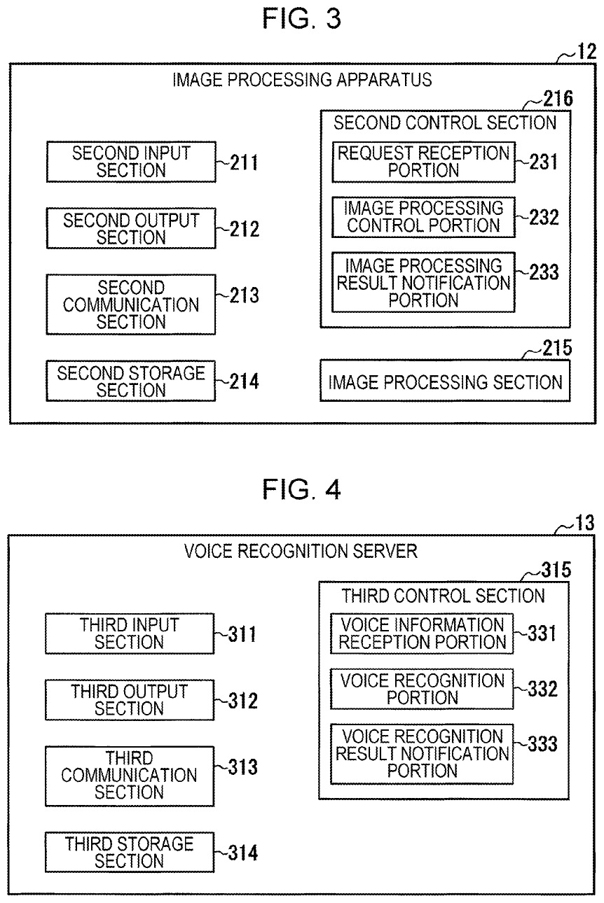

FIG. 3 is a diagram illustrating a configuration of functional blocks of the image processing apparatus 12 according to the embodiment. The image processing apparatus 12 includes a second input section 211, a second output section 212, a second communication section 213, a second storage section 214, an image processing section 215, and a second control section 216. The second control section 216 includes a request reception portion 231, an image processing control portion 232, and an image processing result notification portion 233.

The second input section 211 has an operation device operated by a user of the image processing apparatus 12. The operation device may be a key or the like. The second output section 212 has a screen on which information is displayed, a speaker outputting sound, and the like. Screens of the second input section 211 and the second output section 212 may be integrated by using a touch panel. The second communication section 213 is an interface that performs communication with other apparatuses. The second storage section 214 is a memory that stores various types of information. The image processing section 215 executes predetermined image processing. The image processing section 215 executes print processing, and thus executes a process of printing a print target image on a medium such as paper.

The second control section 216 is a controller including a processor and the like and performing various types of control. The request reception portion 231 receives a request from the information processing apparatus 11. The request is a request corresponding to an image processing instruction sent from the information processing apparatus 11. The request includes a setting content for image processing. The image processing control portion 232 controls the image processing section 215 and causes the image processing section 215 to execute image processing based on the request received by the request reception portion 231. The image processing result notification portion 233 notifies the information processing apparatus 11 of the processing result of the image processing. The processing result of the image processing may include a final processing result of the image processing and a result in the middle of the image processing.

Here, a case where the user 31 of the information processing apparatus 11 and the user of the image processing apparatus 12 are the same as each other will be described. These users may be different from each other.

FIG. 4 is a diagram illustrating a configuration of functional blocks of the voice recognition server 13 according to the embodiment. The voice recognition server 13 includes a third input section 311, a third output section 312, a third communication section 313, a third storage section 314, and a third control section 315. The third control section 315 includes a voice information reception portion 331, a voice recognition portion 332, and a voice recognition result notification portion 333.

The third input section 311 has an operation device operated by a manager of the voice recognition server 13. The operation device may be a keyboard or a mouse. The third output section 312 has a screen on which information is displayed, a speaker outputting sound, and the like. The third communication section 313 is an interface that performs communication with other apparatuses. The third storage section 314 is a memory that stores various types of information.

The third control section 315 is a controller including a processor and the like and performing various types of control. The voice information reception portion 331 receives voice information from the information processing apparatus 11. The voice recognition portion 332 performs a process of recognizing the voice on the voice information received by the voice information reception portion 331. The process is a process of analyzing the voice and specifying a content delivered by the voice. The content is a content for an instruction. The process includes a process of identifying a person who emitted the voice. The voice recognition result notification portion 333 notifies the information processing apparatus 11 of information regarding the result of the process performed by the voice recognition portion 332.

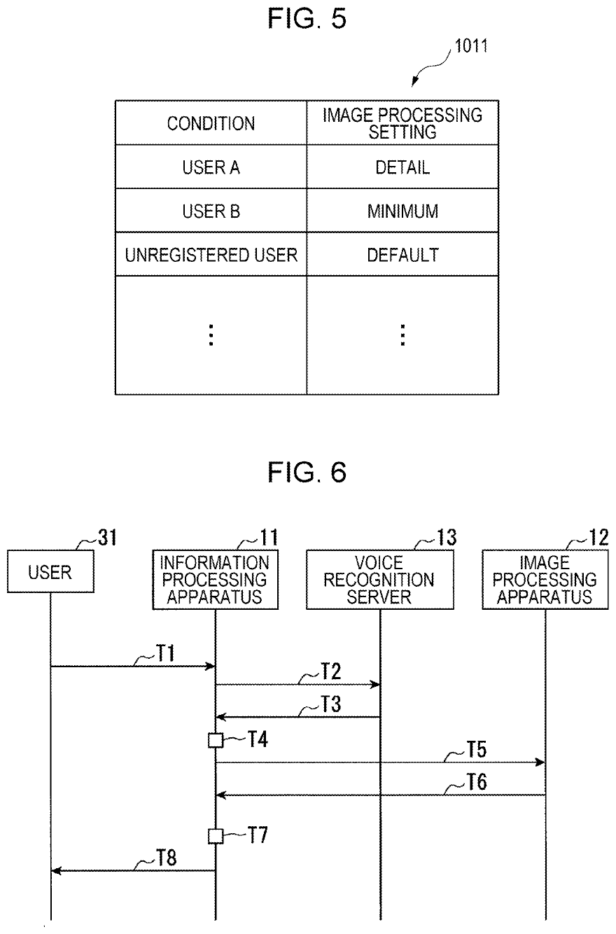

FIG. 5 is a diagram illustrating an example of correspondence information 1011 according to the embodiment. The correspondence information 1011 is stored in the first storage section 114 of the information processing apparatus 11. The correspondence information 1011 may be stored in the first storage section 114 as a default setting in the information processing apparatus 11 or the like in advance, or may be stored in the information processing apparatus 11 or the like at any timing. The correspondence information 1011 may be a content that is initially set by an application. The correspondence information 1011 stored in the first storage section 114 may be rewritten or erased according to the operation of the user 31 or automatically by the information processing apparatus 11. Each of the correspondences defined in the correspondence information 1011 may be managed in the information processing apparatus 11 in a state in which the correspondence is used at all times, or may be managed to be switchable between a used state and an unused state. The switching may be performed according to an operation performed by the user 31, or may be automatically performed by an apparatus such as the information processing apparatus 11.

The correspondence information 1011 stores conditions and image processing settings in correlation with each other. The conditions may be various conditions and include identification information of the user 31. The condition may include an aspect for operation input. The image processing settings may include various setting contents related to image processing. As setting contents for the image processing, a setting content for determining a condition for the image processing may be used, or other setting contents related to the image processing may be used.

FIG. 5 illustrates examples of conditions and image processing settings. A condition such as a user A is correlated with an image processing setting such as a detail. This is a correspondence that, when the user 31 is the user A, an aspect of performing a detailed image processing setting is used. A condition such as a user B and a minimum image processing setting are correlated with each other. This is a correspondence that, when the user 31 is the user B, an aspect of performing the minimum image processing setting is used. A condition such as an unregistered user is correlated with an image processing setting such as default. This is a correspondence that when the user 31 is the unregistered user, an aspect of performing the default image processing setting is used.

Here, the user A indicates a specific person, and the user B indicates another specific person. Features of voice of the user A and features of voice of the user B are registered in advance in a functional portion for identifying the users, and a user corresponding to the user 31 is identified based on features of voice of the user 31. The functional portion is the voice recognition portion 332 of the voice recognition server 13. The unregistered user indicates a user that is not registered, and individual users are not specified.

The image processing setting “detail” indicates an aspect in which a setting content for a detailed setting item is used as a setting content for image processing. The detailed setting item may include not only standard setting items such as a paper size, simplex/duplex printing, enlargement/reduction printing, and a paper feed cassette, but also specialized setting items such as layout printing, face-up/face-down paper ejection, and saddle stitching. The image processing setting “minimum” indicates an aspect in which a setting content for a minimum setting item is used as a setting content for image processing. The minimum setting item includes fewer necessary minimum setting items than the standard setting items. The minimum setting item may include paper size designation. The image processing setting “default” indicates an aspect in which a setting content for a default setting item is used as a setting content for image processing. The default setting item may be a standard setting item. The default setting item may include a setting for automatically selecting a paper feed cassette and designation of A4 as a paper size. With the image processing setting “default” as a reference, a detailed image processing setting is provided to a person who is expected to be more familiar with image processing than in the reference, and, conversely, a simple image processing setting is provided to a person who is expected to be less familiar with image processing than in the reference. Here, any setting item for the default image processing setting and any setting item for the standard image processing setting may be set. These setting items may be the same as each other.

Here, FIG. 5 illustrates an example of the correspondence between the condition and the image processing setting, but various correspondences may be used. The setting content for the image processing may be a content representing a range of the image processing permitted to be executed by the image processing apparatus 12. When the condition that the user 31 is the user A is satisfied, a setting content that overall image processing that can be executed by the image processing apparatus 12 is permitted may be used. When the condition that the user 31 is the user B is satisfied, a setting content that a predetermined part of the image processing that can be executed by the image processing apparatus 12 is permitted may be used. When the condition that the user 31 is the unregistered user is satisfied, a setting content that no image processing that can be executed by the image processing apparatus 12 is permitted may be used. As described above, the setting content for the image processing may be a content for restricting part or the whole of the image processing.

The unregistered user may not be set in the correspondence information 1011. In this case, when the user 31 is an unregistered user, operation inputs except for an operation input for a predetermined process are invalidated in the information processing apparatus 11. The predetermined process may be freely set. In another example, when the user 31 is an unregistered user, all operation inputs may be invalidated in the information processing apparatus 11.

A display content for a user interface performed by an application may be used as the setting content for the image processing. Consequently, a display content for a user interface may be customized for each user.

The image processing setting may include an aspect of a notification related to image processing. The condition of the user A, the condition of the user B, and the condition of the unregistered user may be respectively correlated with a notification aspect a, a notification aspect b, and a notification aspect c. The notification aspect may be various notification aspects.

Each of the notification aspect a, the notification aspect b, and the notification aspect c represents a content of a predetermined notification aspect. The notification aspect a, the notification aspect b, and the notification aspect c may set whether or not a notification using voice is to be performed. The notification aspect a, the notification aspect b, and the notification aspect c may set a voice output level when the notification using voice is to be performed. The notification aspect a, the notification aspect b, and the notification aspect c may set the duration of notification when the notification using voice is to be performed.

The information processing apparatus 11 may perform control of changing a level of the output voice according to noise around the information processing apparatus 11 when the notification using the voice is performed. In this case, the level of the noise is used as a condition, and a volume level of voice used for the notification is a notification aspect. The volume level of voice may be simply referred to as a volume or the like. The information processing apparatus 11 causes the sound level detection portion 171 to detect a level of surrounding sound. The information processing apparatus 11 causes the notification selection portion 197 to decrease a volume level of notification voice as the detected sound level becomes lower, and increases a volume level of notification voice as the detected sound level becomes higher. Alternatively, the information processing apparatus 11 causes the notification selection portion 197 to compare the detected sound level with a predetermined threshold value, and sets a volume level of notification voice to a predetermined low volume level when the detected sound level is equal to or lower than the threshold value, and sets the volume level of notification voice to a predetermined high volume level when the detected sound level is more than the threshold value. Two or more threshold values may be provided, and volume levels of notification voice may be switched in three or more steps. In a case where such a correspondence is used, a volume level of notification voice decreases when a level of surrounding noise is low, and a volume level of the notification voice increases when a level of surrounding noise is high.

There may be a configuration in which the information processing apparatus 11 causes the notification selection portion 197 to select a notification aspect according to a condition including a result of the identification of the user 31 performed based on the voice of the user 31. The identification of the user 31 may be performed by the information processing apparatus 11 or the voice recognition server 13.

FIG. 6 is a diagram illustrating a sequence of processes performed in the image processing system 1 according to the embodiment. FIG. 6 schematically illustrates the user 31, the information processing apparatus 11, the image processing apparatus 12, and the voice recognition server 13. The Processes T1 to T8 will be described.

### Process T1

The user 31 performs an operation input by using the first operation input portion 131-1. The information processing apparatus 11 causes the input information acquisition portion 191 to acquire input information according to the operation input. The operation input is an operation input using voice.

### Process T2

When the input information acquisition portion 191 acquires voice input information, the information processing apparatus 11 causes the first communication section 113 to transmit the voice to the voice recognition server 13. The voice transmitted here may be voice itself or voice data obtained by processing the voice. The voice includes information represented by the voice. Hereinafter, the voice or the voice data will be simply referred to as voice. The voice recognition server 13 receives the voice from the information processing apparatus 11 via the third communication section 313.

### Process T3

The voice recognition server 13 causes the voice information reception portion 331 to receive the voice received via the third communication section 313. The voice recognition server 13 causes the voice recognition portion 332 to recognize the voice. The voice recognition server 13 transmits the recognition result of the voice to the information processing apparatus 11 via the third communication section 313. The information processing apparatus 11 receives the recognition result of the voice from the voice recognition server 13 via the first communication section 113.

Here, the recognition result of the voice includes information indicating a result of identifying the user 31 who has emitted the voice. The information includes identification information such as a number assigned in advance to the user 31 who has emitted the voice. Correspondence information between voice features and information for identifying the user 31 is set in advance in the voice recognition server 13. In the voice recognition server 13, the correspondence information is stored in the third storage section 314. Correspondence information between the identification information and information for specifying the user 31 is set in advance in the information processing apparatus 11. In the information processing apparatus 11, the correspondence information is stored in the first storage section 114. With such a configuration, identification information of a person corresponding to voice acquired by the information processing apparatus 11 is specified by the voice recognition server 13, and the user 31 corresponding to the identification information is specified by the information processing apparatus 11. The user 31 who is not registered in the correspondence information is treated as an unregistered user.

Here, the identification information and the information for specifying the user 31 may be the same as each other, and the identification information may be used as the information for specifying the user 31. Correspondence information between voice features and identification information for identifying the user 31 is set in advance in the voice recognition server 13. The recognition result of the voice obtained by the voice recognition server 13 includes the identification information of the user 31 who has emitted the voice. As mentioned above, in the information processing apparatus 11 and the voice recognition server 13, each user 31 may be managed by using the same name such as the “user A”, and a separate correspondence between the name managed in the information processing apparatus 11 and the name managed in the voice recognition server 13 is unnecessary.

### Process T4

The information processing apparatus 11 causes the instruction acquisition portion 192 to acquire an instruction corresponding to the voice based on the recognition result of the voice received via the first communication section 113. The information processing apparatus 11 causes the user identification information acquisition portion 193 to acquire the identification information of the user 31 corresponding to the voice based on the recognition result of the voice received via the first communication section 113. The information processing apparatus 11 causes the image processing setting control portion 194 to determine a setting content for image processing based on the information acquired by the user identification information acquisition portion 193, and controls the determined setting content to be used.

### Process T5

The information processing apparatus 11 causes the image processing request portion 195 to transmit information indicating a content of the instruction to the image processing apparatus 12 via the first communication section 113 based on the instruction acquired by the instruction acquisition portion 192 and the setting content for image processing controlled by the image processing setting control portion 194, and thus requests the image processing apparatus 12 to perform image processing according to the instruction. The image processing apparatus 12 receives information indicating the content of the instruction from the information processing apparatus 11 via the second communication section 213.

The information processing apparatus 11 causes the image processing request portion 195 to transmit print target data to the image processing apparatus 12 via the first communication section 113. The data may be stored in an apparatus other than the information processing apparatus 11. In this case, the image processing request portion 195 of the information processing apparatus 11 performs control such that the image processing apparatus 12 acquires the print target data. In an example, the information processing apparatus 11 may cause the image processing request portion 195 to transmit information indicating a storage location of the print target data to the image processing apparatus 12 via the first communication section 113. The request reception portion 231 of the image processing apparatus 12 receives the print target data from the storage location via the second communication section 213 based on information indicating the storage location. For example, the storage location may be any apparatus other than the information processing apparatus 11. In another example, the image processing request portion 195 of the information processing apparatus 11 gives an instruction such that the print target data is transmitted to the image processing apparatus 12 from the storage location of the print target data. In this case, the print target data is transmitted from the storage location to the image processing apparatus 12. The storage location may be any apparatus other than the information processing apparatus 11.

### Process T6

The image processing apparatus 12 causes the request reception portion 231 to receive the image processing request based on the information received via the second communication section 213. The image processing apparatus 12 controls the image processing section 215 by using the image processing control portion 232 based on the image processing request received via the request reception portion 231, and thus executes the image processing. The image processing apparatus 12 causes the image processing result notification portion 233 to transmit the processing result of the image processing to the information processing apparatus 11 via the second communication section 213, and thus notifies the information processing apparatus 11 of the processing result. The information processing apparatus 11 receives the processing result of the image processing from the image processing apparatus 12 via the first communication section 113. The information processing apparatus 11 causes the image processing result acquisition portion 196 to acquire information indicating the processing result of the image processing based on the information received via the first communication section 113.

### Process T7

The information processing apparatus 11 causes the notification selection portion 197 to select a notification aspect. The notification selection portion 197 may select a notification aspect based on the correspondence information 1011, and the notification aspect is an example of an image processing setting.

### Process T8

The information processing apparatus 11 notifies the user 31 of the processing result of the image processing by using the notification aspect selected by the notification selection portion 197 based on the information acquired by the image processing result acquisition portion 196. As the notification aspect, an aspect of the first notification portion 151-1 performing a notification is used.

In the Process T4, the information processing apparatus 11 may control the image processing setting control portion 194 to allow the user 31 to perform work of setting the determined setting content for the image processing. The control includes a control of outputting information for prompting the user 31 to perform work of setting the setting content through screen display, and control of receiving a setting of the setting content based on an operation performed by the user 31. Consequently, each user 31 may perform work of setting a setting content for the image processing determined for each user 31. When the setting content for the image processing is a setting content that it is not necessary for the user 31 to perform work of setting, the information processing apparatus 11 performs control such that a setting content for the image processing determined by the image processing setting control portion 194 is used.

Although the configuration for controlling an image processing setting with the information processing apparatus 11 has been described, in another example, the image processing apparatus 12 may have a function for controlling an image processing setting based on information indicating a recognition result of voice information. In this case, the image processing apparatus 12 has the same function as the function of the image processing setting control portion 194, and performs control of determining a setting content for image processing for each user 31. The image processing apparatus 12 may receive identification information of the user 31 from the information processing apparatus 11 and control an image processing setting based on the information.

Although the configuration in which the information processing apparatus 11 requests voice recognition to the voice recognition server 13 has been described, in another example, a configuration in which the image processing apparatus 12 requests voice recognition to the voice recognition server 13 may be used. The information processing apparatus 11 causes the instruction acquisition portion 192 to transmit the voice acquired by the input information acquisition portion 191 to the image processing apparatus 12 via the first communication section 113. The image processing apparatus 12 receives the voice from the information processing apparatus 11 via the second communication section 213. The image processing apparatus 12 causes the request reception portion 231 to transmit the received voice to the voice recognition server 13 via the second communication section 213. The image processing apparatus 12 causes the request reception portion 231 to receive information indicating the recognition result of the voice from the voice recognition server 13 via the second communication section 213. The image processing apparatus 12 causes the request reception portion 231 to transmit information indicating the recognition result of the voice to the information processing apparatus 11 via the second communication section 213.

Although the configuration in which the information processing apparatus 11 receives the operation input by the voice performed by the user 31 has been described, a configuration in which the image processing apparatus 12 receives the operation input by the voice of the user 31 may be used in another example. The image processing apparatus 12 receives an operation input using voice of the user 31 through the second input section 211. The image processing apparatus 12 causes the request reception portion 231 to transmit information indicating the received voice to the voice recognition server 13 via the second communication section 213. The image processing apparatus 12 causes the request reception portion 231 to receive information indicating the recognition result of the voice from the voice recognition server 13 via the second communication section 213. The image processing apparatus 12 causes the request reception portion 231 to transmit information indicating the recognition result of the voice to the information processing apparatus 11 via the second communication section 213.

The image processing apparatus 12 may have a function of controlling the image processing setting based on the information indicating the recognition result of the voice. In this case, the image processing apparatus 12 has the same function as the function of the image processing setting control portion 194, and performs control of determining a setting content for image processing for each user 31. The image processing apparatus 12 may receive information indicating the recognition result of the voice from the voice recognition server 13 and control an image processing setting based on the information.

Another example of an apparatus having the voice recognition function will be described. The information processing apparatus 11 may have the voice recognition function. In this case, the information processing apparatus 11 performs voice recognition based on voice acquired by the input information acquisition portion 191. The information processing apparatus 11 causes the instruction acquisition portion 192 to acquire an instruction based on the recognition result of the voice. The information processing apparatus 11 causes the user identification information acquisition portion 193 to acquire the identification result of the user 31 based on the recognition result of the voice. In such a configuration, the voice recognition server 13 may not be used.

The image processing apparatus 12 may have the voice recognition function. In this case, the information processing apparatus 11 causes the instruction acquisition portion 192 to transmit the voice acquired by the input information acquisition portion 191 to the image processing apparatus 12 via the first communication section 113. The image processing apparatus 12 receives the information indicating the voice from the information processing apparatus 11 via the second communication section 213. The image processing apparatus 12 performs voice recognition based on the received voice. The image processing apparatus 12 causes the request reception portion 231 to receive a request for image processing based on the recognition result of the voice. In this case, the image processing apparatus 12 identifies the user 31 based on the recognition result of the voice. The image processing apparatus 12 may transmit information indicating the identification result of the user 31 to the information processing apparatus 11, or the information may be processed by the image processing apparatus 12 instead of transmitting the information to the information processing apparatus 11. In such a configuration, the voice recognition server 13 may not be used.

Another example of an apparatus having a function of selecting a notification aspect by using the notification selection portion 197 will be described. Here, this function will be referred to as a notification aspect selection function. The voice recognition server 13 may have the notification aspect selection function. In this case, the information processing apparatus 11 causes the instruction acquisition portion 192 to transmit information required to select a notification aspect by using the notification aspect selection function to the voice recognition server 13 via the first communication section 113. The voice recognition server 13 receives the information from the information processing apparatus 11 via the third communication section 313, selects a notification aspect by using the notification aspect selection function based on the received information, and transmits aspect information indicating the selected notification aspect to the information processing apparatus 11 via the third communication section 313. The information processing apparatus 11 receives the aspect information from the voice recognition server 13 via the first communication section 113, and causes the instruction acquisition portion 192 to specify the notification aspect based on the received aspect information.

The image processing apparatus 12 may have the notification aspect selection function. In this case, the information processing apparatus 11 causes the instruction acquisition portion 192 to transmit, to the image processing apparatus 12 via the first communication section 113, information required to select a notification aspect by using the notification aspect selection function. The image processing apparatus 12 receives the information from the information processing apparatus 11 via the second communication section 213, selects a notification aspect by using the notification aspect selection function based on the received information, and transmits information indicating the selected aspect information to the information processing apparatus 11 via the second communication section 213. The information processing apparatus 11 receives the information from the image processing apparatus 12 via the first communication section 113, and causes the instruction acquisition portion 192 to specify the notification aspect based on the received information.

A separate apparatus may have the notification aspect selection function. The separate apparatus is an apparatus that is different from the information processing apparatus 11, the image processing apparatus 12, and the voice recognition server 13. The separate apparatus may be included in the image processing system 1. The information processing apparatus 11 causes the instruction acquisition portion 192 to transmit the information required to select a notification aspect by using the notification aspect selection function to the separate apparatus via the first communication section 113. The separate apparatus receives the information from the information processing apparatus 11, selects a notification aspect by using the notification aspect selection function based on the received information, and transmits information indicating the selected notification aspect to the information processing apparatus 11. The information processing apparatus 11 receives the information from the separate apparatus via the first communication section 113, and causes the instruction acquisition portion 192 to specify the notification aspect based on the received information.

Another example of an apparatus having the function of identifying the user 31 based on voice of the user 31 will be described. Here, this function will be referred to as a user identification function. The user identification function is configured as a part of the function of the voice recognition portion 332 of the voice recognition server 13. Information used to identify the user 31 is stored in the voice recognition server 13.

The information processing apparatus 11 may have the user identification function. In this case, the information used to identify the user 31 is stored in the information processing apparatus 11. The user identification function may be included in the functions of the user identification information acquisition portion 193. The information processing apparatus 11 having the user identification function specifies identification information of the user 31 corresponding to voice acquired by the input information acquisition portion 191 based on correspondence information between preset voice features and identification information of the user 31. The information processing apparatus 11 has the user identification function, but, when using another function of the voice recognition server 13, the information processing apparatus 11 interacts with the voice recognition server 13.

A description will be made of process in which the information processing apparatus 11 detects a status of the image processing apparatus 12. The information processing apparatus 11 determines that the image processing is finished when the image processing result acquisition portion 196 receives a processing result of the image processing from the image processing apparatus 12. On the other hand, the information processing apparatus 11 determines that the image processing is not finished when the image processing result acquisition portion 196 does not receive information regarding the processing result of the image processing from the image processing apparatus 12.

The information processing apparatus 11 causes the image processing result acquisition portion 196 to determine whether or not the image processing requested to the image processing apparatus 12 is normally finished. A case where the image processing is finished but the image processing is not normally finished, the information processing apparatus 11 is determined to be a case where the image processing is abnormally finished. The processing result of the image processing of which the image processing apparatus 12 notifies the information processing apparatus 11 is assumed to include information for identifying whether the image processing is normally finished or the image processing is abnormally finished.

The information processing apparatus 11 causes the image processing result acquisition portion 196 to determine whether or not the image processing requested to the image processing apparatus 12 is in an error status. The status may be a status of the image processing apparatus 12. Various errors may be used as the error. As the error, there may be the use of an error that the image processing is not finished when a predetermined time has elapsed after the information processing apparatus 11 requested the image processing to the image processing apparatus 12. The predetermined time is a timeout time.

The error may include an error due to which image processing cannot be continued and an error due to which image processing can be continued. When an error that requires resetting of the image processing apparatus 12 occurs during image processing, typically, it is not possible to continue the image processing from the middle thereof. When an error of paper exhaustion occurs during image processing, the image processing can be continued from the middle thereof.

When print processing is exemplified, the information processing apparatus 11 checks a status of the image processing apparatus 12 during the print processing. The term “during print processing” refers to a period from the time when print data is sent to the image processing apparatus 12 to the time when printing of the print data is finished by the image processing apparatus 12. When the information processing apparatus 11 determines that an error has occurred based on the status during the print processing, the information processing apparatus 11 performs a notification of a content of the error as a processing result. The information processing apparatus 11 performs a notification of end of printing when the printing is finished. The information processing apparatus 11 determines that the printing is finished based on a change in the status. The status of the image processing apparatus 12 is busy when printing is in progress without an error, and is idle when printing is finished.

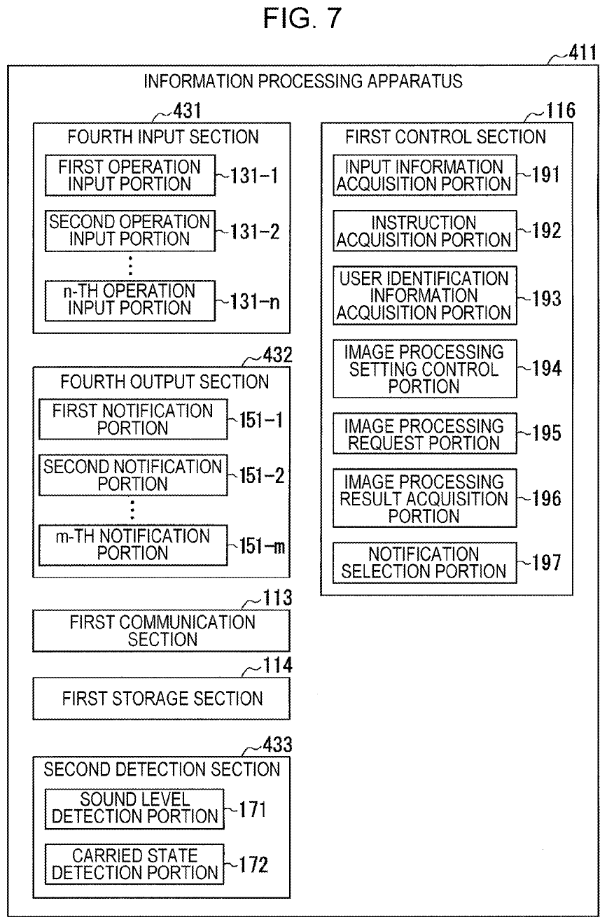

FIG. 7 is a diagram illustrating a configuration of functional blocks of an information processing apparatus 411 according to another example of the embodiment. The information processing apparatus 411 is different from the information processing apparatus 11 illustrated in FIG. 2 in terms of having a function of receiving an operation input by using transmission means other than voice and a function of performing a notification by using transmission means other than voice. In this example, a description will be made of a case where the information processing apparatus 411 is used instead of the information processing apparatus 11 illustrated in FIG. 1. The information processing apparatus 411 may be various apparatuses, for example, a smartphone, a smart speaker, or a smart speaker with a display device.

The configuration of the functional blocks of the information processing apparatus 411 will be described with reference to FIG. 7. Here, constituents similar to those illustrated in FIG. 2 are performed the same reference numerals, and detailed description thereof will be omitted.

The information processing apparatus 411 includes a fourth input section 431, a fourth output section 432, a first communication section 113, a first storage section 114, a second detection section 433, and a first control section 116. The first communication section 113, the first storage section 114, and the first control section 116 generally have the same functions as those of the respective constituents illustrated in FIG. 2, but are applicable to the constituents relating to the differences in this example.

The fourth input section 431 includes a first operation input portion 131-1, a second operation input portion 131-2, . . . , and an n-th operation input portion 131-n as n operation input portions. Here, n represents an integer of 2 or greater. The first operation input portion 131-1 receives an operation input using voice as in the case illustrated in FIG. 2.

The fourth output section 432 includes a first notification portion 151-1, a second notification portion 151-2, . . . , and an m-th notification portion 151-m as m notification portions. Here, m represents an integer of 2 or greater. In addition, n and m may have the same value or different values. The first notification portion 151-1 performs a notification using voice as in the case illustrated in FIG. 2.

The second detection section 433 includes a sound level detection portion 171 and a carried state detection portion 172. The sound level detection portion 171 detects a sound level in the same manner as illustrated in FIG. 2. The carried state detection portion 172 detects a state in which the information processing apparatus 411 is carried by the user 31.

The fourth input section 431 inputs various types of information. The first operation input portion 131-1 to the n-th operation input portion 131-n receive operation inputs performed by the user 31 by using respective types of transmission means. Each of the second operation input portion 131-2 to the n-th operation input portion 131-n may receive an operation input by using any transmission means. Each of the first operation input portion 131-1 to the n-th operation input portion 131-n may receive an operation input by using different transmission means, or two or more of the first operation input portion 131-1 to the n-th operation input portion 131-n may receive operation inputs by using the same transmission means.

The second operation input portion 131-2 receives an operation input by using a manual operation. The second operation input portion 131-2 has an operation device such as a keyboard, a mouse, or a touch panel, and inputs information regarding a content of an operation on the operation device performed by the user 31. The third operation input portion 131-3 receives an operation input by using the captured image. The third operation input portion 131-3 has a camera and receives information regarding a captured image of the user 31. A motion or a pose of the user 31 reflected in the image is converted into a content of the operation. The motion or the pose of the user 31 may be referred to as a gesture.

A device that acquires information for receiving an operation input by using each of the second operation input portion 131-2 to the n-th operation input portion 131-n may be provided outside the information processing apparatus 411 instead of being provided in the information processing apparatus 411. The operation device that acquires information regarding a manual operation, the camera that acquires information about an image, and the like may be provided outside the information processing apparatus 411 instead of being provided in the information processing apparatus 411. Each of the second operation input portion 131-2 to the n-th operation input portion 131-n inputs an operation by using each type of device provided outside the information processing apparatus 411.

Any type of transmission means for receiving an operation input in each of the first operation input portion 131-1 to the n-th operation input portion 131-n may be assigned, and the respective numbers of the first operation input portion 131-1 to the n-th operation input portion 131-n are examples and may be any numbers. Voice, a manual operation, an image, and the like may be assigned to an operation input portion with any number among the first operation input portion 131-1 to the n-th operation input portion 131-n.

The fourth output section 432 outputs various types of information. The first notification portion 151-1 to the m-th notification portion 151-m notify the user 31 by using respective types of transmission means. Each of the second notification portion 151-2 to the m-th notification portion 151-m may make the notification using any transmission means. Each of the first notification portion 151-1 to the m-th notification portion 151-m may perform a notification by using different transmission means, or two or more of the first notification portion 151-1 to the m-th notification portion 151-m may perform notifications by using the same transmission means.

The second notification portion 151-2 performs a notification by using screen display as transmission means. The second notification portion 151-2 has a screen, and outputs and displays information indicating a notification content on the screen to perform a notification of the notification content. The third notification portion 151-3 performs a notification by using vibration as transmission means. The third notification portion 151-3 has a vibrator, and generates vibration according to information indicating a notification content with the vibrator to perform a notification of the notification content.

The device that outputs the information indicating the notification content by each of the second notification portion 151-2 to the m-th notification portion 151-m may be provided outside the information processing apparatus 411 instead of being provided in the information processing apparatus 411. The screen for displaying and outputting information, the vibrator for generating vibration, or the like may be provided outside the information processing apparatus 411 instead of being provided in the information processing apparatus 411. Each of the second notification portion 151-2 to the m-th notification portion 151-m performs a notification by using each type of device provided outside the information processing apparatus 411.

Any type of transmission means for performing a notification in each of the first notification portion 151-1 to the n-th notification portion 151-n may be assigned, and the respective numbers of the first notification portion 151-1 to the n-th notification portion 151-n are examples and may be any numbers. Voice, an image, vibration, and the like may be assigned to a notification portion with any number among the first notification portion 151-1 to the n-th notification portion 151-n.

The input information acquisition portion 191 of the first control section 116 acquires information that is input by the fourth input section 431. The input information acquisition portion 191 acquires information regarding an operation input that is received by each of the first operation input portion 131-1 to the n-th operation input portion 131-n.

In Process T1 illustrated in FIG. 6, the user 31 performs an operation input by using one or more of the first operation input portion 131-1 to the n-th operation input portion 131-n. The information processing apparatus 411 causes the input information acquisition portion 191 to acquire input information according to the operation input. In Process T8 illustrated in FIG. 6, the information processing apparatus 411 notifies the user 31 of information indicating the result of the image processing by using the notification aspect selected by the notification selection portion 197 based on the information acquired by the image processing result acquisition portion 196. As the notification aspect, an aspect of one or more of the first notification portion 151-1 to the m-th notification portion 151-m performing notifications is used. The information processing apparatus 411 causes the notification selection portion 197 to transmit a signal for performing a notification to a selected notification portion based on the result of the image processing performed by the image processing apparatus 12.

In the information processing apparatus 411, when there is an operation input using transmission means other than voice, the following process is performed instead of a process of accessing the voice recognition server 13 as in Processes T1 to T4. The information processing apparatus 411 causes the input information acquisition portion 191 to acquire input information according to the operation input. It is assumed that the operation input is a manual operation input or the like. In Process T1, the information processing apparatus 411 causes the instruction acquisition portion 192 to acquire an instruction corresponding to the input information based on the input information acquired by the input information acquisition portion 191. In Process T4, the information processing apparatus 411 causes the image processing request portion 195 to transmit information indicating a content of the instruction to the image processing apparatus 12 via the first communication section 113 based on the instruction acquired by the instruction acquisition portion 192, and thus requests the image processing apparatus 12 to perform image processing corresponding to the instruction. The request may include a content of the image processing setting when the content of the image processing setting is specified, or may not include the content of the image processing setting. The image processing apparatus 12 receives the information indicating the content of the instruction from the information processing apparatus 411 via the second communication section 213. Here, Process T2 and Process T3 are not performed. The processes after Process T5 are performed.

An example of correspondence between a condition and a notification aspect will be described. The notification aspect may be included in the image processing setting illustrated in FIG. 5. As the notification aspect a, the notification aspect b, and the notification aspect c, for example, a notification aspect of performing a notification with voice, a notification aspect of performing a notification with display, and a notification aspect of performing a notification with voice and display may be used.

The condition may include not only information for identifying the user 31 but also conditions regarding one or more elements such as an aspect of operation input, a result of image processing performed by the image processing apparatus 12, a predetermined situation of the information processing apparatus 411, a time, the past history, and a situation of background sound. One condition may be a condition regarding one element, or a condition in which two or more elements are combined with each other. As the image processing setting, not only information regarding an item of a parameter used for the image processing but also information regarding an item indicating a result of the image processing may be used.

As the notification aspect, an aspect using one of notification methods such as voice or display may be used, or a notification aspect in which two or more notification methods are combined with each other may be used.

The example in FIG. 5 illustrates a case where a notification aspect may be included in an image processing setting. In this example, a case has been described in which an image processing setting other than a notification aspect and the notification aspect are correlated with the same condition. In another example, image processing settings other than notification aspects and the notification aspects may be correlated with the respective conditions. A certain condition may be correlated with an image processing setting other than a notification aspect, and another condition may be correlated with the notification aspect.

A condition such as an operation input using voice and a notification aspect such as a notification using voice may be correlated with each other. The correlation is a correlation using an aspect of performing a notification using voice when the user 31 performs an operation input using voice. A condition such as a manual operation input may be correlated with a notification aspect of performing a notification using display. The correlation is a correlation using an aspect of performing a notification using display when the user 31 performs a manual operation input. A condition such as an operation input using an image may be correlated with a notification aspect of performing a notification using voice and display. This correlation is a correlation using an aspect of performing a notification using both voice and display when the user 31 performs an operation input using an image. As an aspect of performing an operation input using an image, an aspect of performing an operation input according to a motion or a pose of the user 31 reflected in the image may be used.

Various correspondences may be used as a correspondence between a condition and an image processing setting other than a notification aspect. Similarly, various correspondences may be used as a correspondence between a condition and a notification aspect.

In an example, in the information processing apparatus 411, by using the notification selection portion 197, the information processing apparatus 411 may perform control using an aspect of performing a notification using voice when a detected sound level is equal to or less than a predetermined threshold value, and performing a notification using both vibration and screen display when the detected sound level exceeds the threshold value.

As noise included in voice, sound other than voice of persons including the user 31 may be used, or sound other than voice of the user 31 may be used. Sound in a predetermined frequency region may be used as noise included in voice. As the predetermined frequency region, a region out of a main region in a human voice frequency region may be used. Noise may be referred to as unwanted sound, background sound, or the like.

The notification selection portion 197 selects a notification aspect using transmission means other than voice when a level of noise included in the voice exceeds a first threshold value based on an operation input using the voice. The first threshold value is any value, and an upper limit value of a noise level allowed for a notification using voice may be used. When a noise level is high, it is considered that a notification using screen display or the like is more preferably used than a notification using voice.

The notification selection portion 197 selects a notification aspect using voice with a level lower than a third threshold value when a level of the voice is less than a second threshold value, based on an operation input using the voice. The second threshold value may be any value. When the voice level in the operation input voice is low, it is considered possible to notify the user 31 of the content of the notification by the notification with the low voice. The third threshold value may be any value, and the same value as the second threshold value may be used, or a value that is different from the second threshold value may be used. The voice with the level less than the third threshold value may be voice with any level. The voice with the level less than the third threshold value may be changed according to a level of noise. The voice with the level less than the third threshold value may be voice with a level higher than a level of noise.

The notification selection portion 197 selects a notification aspect using both voice and transmission means other than the voice when a level of the voice is less than the second threshold value, based on an operation input using the voice. When a level of the voice in the operation input is low, it may be possible to notify the user 31 of a notification content through a notification using the low voice, but, at the same time, it may be possible to reliably notify the user 31 of the notification content through a notification using screen display or the like.

The information processing apparatus 411 may perform control using an aspect of performing a notification by using vibration when it is determined that a condition that the information processing apparatus 411 is worn by the user 31 is satisfied regardless of the type of operation input serving as a trigger to start image processing. The type of operation input indicates types such as a voice operation input and a manual operation input. The information processing apparatus 411 is a portable apparatus that can be worn by the user 31. The information processing apparatus 411 causes the carried state detection portion 172 to determine whether or not the information processing apparatus 411 is worn by the user 31. Various sensors may be used as the carried state detection portion 172.

As a condition that the information processing apparatus 411 is worn by the user 31, a condition that the information processing apparatus 411 is worn by the specific user 31 may be used. The information processing apparatus 411 has a function of determining whether or not a certain user 31 is the specific user 31.

In the information processing apparatus 411, a notification content and a vibration pattern may be correlated with each other. A vibration pattern for a notification of normal end may be different from a vibration pattern for a notification of abnormal finishing. The user 31 wearing the information processing apparatus 411 can recognize the presence or absence of an error according to a vibration pattern without receiving a notification using screen display. This is particularly effective when the user 31 cannot view a screen.

The information processing apparatus 411 may perform control using an aspect of performing a notification by using voice when it is determined that a condition that the information processing apparatus 411 is not worn by the user 31 is satisfied regardless of the type of operation input serving as a trigger to start image processing.

The information processing apparatus 411 may perform control using an aspect of performing a notification by using screen display when it is determined that a condition that the user 31 is viewing the information processing apparatus 411 is satisfied regardless of the type of operation input serving as a trigger to start image processing. The information processing apparatus 411 includes a camera that captures surroundings of the information processing apparatus 411, and determines whether or not the user 31 is viewing the information processing apparatus 411 based on an image captured by the camera. The determination may be performed based on a result of detecting a visual line of the human eye reflected in the image. The camera may have any one of the third operation input portion 131-3 to the n-th operation input portion 131-n. As a condition that the user 31 is viewing the information processing apparatus 411, a condition that the user 31 is gazing at the information processing apparatus 411 may be used. The information processing apparatus 411 may use an aspect of determining that the user 31 is gazing at the information processing apparatus 411 when it is determined that a time when the user 31 is viewing the information processing apparatus 411 continuously or intermittently exceeds a predetermined threshold value.

As a condition that the user 31 is viewing the information processing apparatus 411, for example, a condition that the specific user 31 is viewing the information processing apparatus 411 may be used. The information processing apparatus 411 has a function of determining whether or not a certain user 31 is a specific person.

The information processing apparatus 411 may perform control using an aspect of performing a notification by using both voice and screen display when it is determined that a condition that a notification of abnormality is performed is satisfied regardless of the type of operation input serving as a trigger to start image processing.

The information processing apparatus 411 may perform control using an aspect of performing a notification by using one or both of screen display and vibration when image processing is started through an operation input using voice in a case where it is determined that a condition that the information processing apparatus 411 is in a predetermined mode is satisfied. The predetermined mode may be a mode in which sound output is turned off, that is, a so-called manner mode. In the predetermined mode, a notification using vibration may be turned on.

The information processing apparatus 411 may perform control using an aspect of performing a notification by using the same type of transmission means as the type of transmission means by using which an operation input has been performed. In this case, the information processing apparatus 411 may not perform a notification by using the type of transmission means different from the type of the transmission means by using which the operation input has been performed. The transmission means represents voice, screen display, or the like. The information processing apparatus 411 may perform control using an aspect of performing a notification by using vibration in a case of a normal operation and performing a notification by using voice in a case of an abnormal operation. The information processing apparatus 411 may perform control using an aspect of performing a notification by using predetermined transmission means based on a default setting that is set by the user 31.

A notification snooze function will be described. The information processing apparatus 411 may have a snooze function for notification.

A description will be made of the snooze function when a notification using voice is performed. When a reaction of the user 31 is not detected after a notification is performed by using voice, the information processing apparatus 411 repeatedly performs the notification by using voice or the like after a predetermined time. The reaction of the user 31 is a voice response made by the user 31, or screen tapping performed by the user 31. Such a reaction of the user 31 may be detected by one or more of the first operation input portion 131-1 to the n-th operation input portion 131-n.

A description will be made of the snooze function when a notification using screen display is performed. When a reaction of the user 31 is not detected after a notification is performed by using screen display, the information processing apparatus 411 performs a notification by using voice after a predetermined time. The reaction of the user 31 is, for example, screen tapping performed by the user 31. Thereafter, the information processing apparatus 411 repeatedly performs the notification by using voice after a predetermined time when the reaction of the user 31 is not detected after the notification by using voice is performed.

With the snooze function, any time may be set as a predetermined time corresponding to a time interval between a certain notification and the next notification. The predetermined time may be a fixed time or may be a time that changes according to the number of repeatedly performed notifications. The predetermined time may be set to be longer as the number of repeatedly performed notifications increases. Any number of repeatedly performed notifications may be set.

As described above, the image processing system 1 according to the present embodiment provides the following program. The information processing apparatus 11 illustrated in FIG. 2 and the information processing apparatus 411 illustrated in FIG. 7 will be collectively described. A computer configuring the information processing apparatuses 11 and 411 is provided with a program for realizing the first to third functions. The first function is a function of acquiring an instruction for image processing and first identification information of the user 31 based on a first operation input that is performed on the information processing apparatuses 11 and 411 by using voice of the user 31. The second function is a function of determining an image processing setting corresponding to the acquired first identification information based on correspondence information in which the first identification information of the user 31 is correlated with the image processing setting. The third function is a function of requesting the image processing apparatus 12 to perform the image processing based on the determined image processing setting and the acquired instruction for the image processing. Here, the first operation input is an operation input received by the first operation input portion 131-1 that receives an operation input using voice. The first identification information indicates identification information of the user 31. The first function is the function of the first operation input portion 131-1, the second function is the function of the image processing setting control portion 194, and the third function is the function of the image processing request portion 195. The second function may include the function of the notification selection portion 197.

Therefore, in the image processing system 1 according to the present embodiment, it is possible to determine an image processing setting appropriate for the user 31 according to identification information of the user 31 based on an operation input using voice performed by the user 31.

In the image processing system 1, when the image processing apparatus 12 is controlled based on an operation input using voice performed by the user 31, the user 31 is identified by the voice for an instruction for controlling the image processing apparatus 12, and the image processing apparatus 12 is controlled with different image processing settings depending on the identified user 31. Consequently, the image processing system 1 can perform switching among different image processing settings depending on the user 31 identified by voice, for an application that requests image processing to the image processing apparatus 12 through an operation input using the voice.

The program in the information processing apparatuses 11 and 411 is a program for causing a computer to realize a fourth function of changing an image processing setting when an acquired instruction includes information regarding a change of the image processing setting. Therefore, the user 31 can change a setting content for image processing. Consequently, an image processing setting appropriate for each user 31 can be performed. The fourth function is the function of the image processing setting control portion 194.

In the image processing system 1 according to the present embodiment, an image processing setting may be set in advance for each user 31 and each piece of operation input transmission means through a voice or manual operation input performed by the user 31. Consequently, in the image processing system 1, when an instruction is performed to the image processing apparatus 12 by an application that requests image processing to the image processing apparatus 12, an image processing setting specific to the user 31 stored in advance can be reflected in the image processing.

In the image processing system 1 according to the present embodiment, since image processing settings are automatically switched for each user 31, for example, it is possible to reduce the time and effort for each user 31 to set an image processing setting each time, and thus usability for the user 31 is improved. When the common image processing apparatus 12 is used from the information processing apparatuses 11 and 411 shared by a plurality of users 31, it is possible to reduce the time and effort for each user 31 to set an image processing setting each time, and thus usability for the user 31 is improved.

The program in the information processing apparatuses 11 and 411 is a program for causing a computer to further realize a fifth function of changing an image processing setting based on the change history regarding the image processing setting. Therefore, the image processing system 1 can change the setting content for the image processing based on the change history. Consequently, in the image processing system 1, it is possible to determine an image processing setting that is estimated to be appropriate for each user 31 based on the past image processing setting. The fifth function is the function of the image processing setting control portion 194.

The program in the information processing apparatuses 11 and 411 is a program causing a computer to further realize a sixth function of changing an aspect of performing a notification of information regarding image processing executed in the image processing apparatus 12 based on the first identification information of the user 31. Therefore, in the image processing system 1, a notification aspect related to image processing can be changed for each user 31. Consequently, in the image processing system 1, it is possible to perform a notification according to an appropriate notification aspect for each user 31. The sixth function is the function of the notification selection portion 197, and may be included in the function of the image processing setting control portion 194.

In the program of the information processing apparatuses 11 and 411, the sixth function is a function of selecting an aspect of performing a notification of information regarding image processing executed by the image processing apparatus 12 corresponding to the first identification information of the user 31 based on information for correlating the first identification information of the user 31 with the notification aspect. Therefore, the image processing system 1 can change a notification aspect related to image processing for each user 31 based on predetermined correspondence information. Consequently, in the image processing system 1, it is possible to perform a notification according to an appropriate notification aspect for each user 31. The correspondence information is the correspondence information 1011 illustrated in FIG. 5.

A control method for the information processing apparatuses 11 and 411 may be provided. In the control method for the information processing apparatuses 11 and 411, an instruction for image processing and the first identification information of the user 31 are acquired based on a first operation input using voice performed on the information processing apparatuses 11 and 411 by the user 31. In the control method for the information processing apparatuses 11 and 411, an image processing setting corresponding to the acquired first identification information is determined based on correspondence information for correlating the first identification information of the user 31 with the image processing setting, and the image processing apparatus 12 is requested to perform image processing based on the determined image processing setting and the acquired instruction for the image processing.

The image processing system 1 may be provided.

The image processing system 1 includes the information processing apparatuses 11 and 411 and the image processing apparatus 12, and has the following configuration. The information processing apparatuses 11 and 411 include an acquisition section that acquires an instruction for image processing and first identification information of the user 31 based on a first operation input using a voice performed by the user 31; the first storage section 114 that stores correspondence information in which the first identification information is correlated with an image processing setting; the image processing setting control portion 194 that determines an image processing setting corresponding to the first identification information acquired by the acquisition section based on the correspondence information stored in the first storage section 114; and the image processing request portion 195 that requests image processing to the image processing apparatus 12 based on the image processing setting determined by the image processing setting control portion 194 and the instruction for the image processing acquired by the acquisition section. The function of the acquisition section that acquires an instruction for image processing is the function of the instruction acquisition portion 192, and the function of the acquisition section that acquires the first identification information of the user 31 is the function of the user identification information acquisition portion 193. The image processing apparatus 12 includes the request reception portion 231 that receives a request for image processing from the information processing apparatuses 11 and 411, and the image processing section 215 that executes image processing based on the request received by the request reception portion 231.

The program for realizing the function of any constituent of any apparatus such as the information processing apparatuses 11 and 411, the image processing apparatus 12, or the voice recognition server 13 described above may be recorded on a computer-readable recording medium, and may be read and executed by a computer system. The “computer system” mentioned here includes an operating system or hardware such as peripheral devices. The “computer-readable recording medium” refers to a portable medium such as a flexible disk, a magneto-optical disk, a ROM, a compact disc (CD)-ROM, or a storage device such as a hard disk built in the computer system. The “computer-readable recording medium” is assumed to include a medium that stores the program for a predetermined time, such as a volatile memory inside the computer system serving as a server or a client when the program is transmitted via a network such as the Internet or a communication line such as a telephone line. The volatile memory may be a RAM. The recording medium may be a non-transitory recording medium.

The program may be transmitted from a computer system that stores the program in a storage device or the like to another computer system via a transmission medium or a transmission wave in the transmission medium. Here, the “transmission medium” for transmitting the program refers to a medium having a function of transmitting information, such as a network such as the Internet or a communication line such as a telephone line. The program may be a program for realizing some of the functions described above. The program may be a so-called difference file, which can realize the above-mentioned function in combination with a program already recorded in the computer system. The difference file may be called a difference program.

The function of any constituent of any apparatus such as the information processing apparatuses 11 and 411, the image processing apparatus 12, or the voice recognition server 13 described above may be realized by a processor. Each process may be realized by a processor that operates based on information such as a program and a computer-readable recording medium that stores information such as the program. Here, in the processor, a function of each constituent may be realized by individual hardware, or the function of each constituent may be realized by integrated hardware. The processor includes hardware, and the hardware may include at least one of a circuit that processes a digital signal and a circuit that processes an analog signal. The processor may be configured by using one or both of one or a plurality of circuit devices mounted on a circuit board, and one or a plurality of circuit elements. An integrated circuit (IC) or the like may be used as the circuit device, and a resistor or a capacitor may be used as the circuit element.

The processor may be a CPU. However, the processor is not limited to the CPU, and various processors such as a graphics processing unit (GPU) or a digital signal processor (DSP) may be used. The processor may be a hardware circuit based on an application specific integrated circuit (ASIC). The processor may be configured with a plurality of CPUs, or may be configured with a hardware circuit including a plurality of ASICs. The processor may be configured with a combination of a plurality of CPUs and a hardware circuit including a plurality of ASICs. The processor may include one or more of amplifier circuits or filter circuits that process an analog signal.

Although the embodiment of the present disclosure has been described in detail with reference to the drawings, a specific configuration is not limited to the embodiment, and includes design and the like within the scope without departing from the spirit of the present disclosure.

What is claimed is:

1. A non-transitory computer-readable storage medium storing a program executed in a computer configuring an information processing apparatus performing communication with an image processing apparatus, the program causing the computer to:
acquire an instruction for image processing and identification information for identifying a user based on an operation input using voice performed on the information processing apparatus by the user;
determine a setting for the image processing corresponding to the acquired identification information based on correspondence information in which the identification information is correlated with the setting for the image processing; and
request the image processing to the image processing apparatus based on the determined setting for the image processing and the acquired instruction for the image processing.

2. The non-transitory computer-readable storage medium according to claim 1, wherein
the setting for the image processing is changed when the acquired instruction includes information regarding a change of the setting for the image processing.

3. The non-transitory computer-readable storage medium according to claim 1, wherein
the setting for the image processing is changed based on a change history related to the setting for the image processing.

4. The non-transitory computer-readable storage medium according to claim 1, wherein
a notification of a processing result of the image processing executed by the image processing apparatus is changed based on the identification information.

5. The non-transitory computer-readable storage medium according to claim 4, wherein
the notification of the processing result of the image processing executed by the image processing apparatus corresponding to the identification information is selected based on information in which the identification information is correlated with the notification.

6. A control method for an information processing apparatus communicating with an image processing apparatus, the control method comprising:
acquiring an instruction for image processing and identification information for identifying a user based on an operation input using voice performed by the user;
determining a setting for the image processing corresponding to the acquired identification information based on correspondence information in which the identification information is correlated with the setting for the image processing; and
requesting the image processing to the image processing apparatus based on the determined setting for the image processing and the acquired instruction for the image processing.

7. The control method for an information processing apparatus according to claim 6, wherein
the setting for the image processing is changed when the acquired instruction includes information regarding a change of the setting for the image processing.

8. The control method for an information processing apparatus according to claim 6, wherein
the setting for the image processing is changed based on a change history related to the setting for the image processing.

9. The control method for an information processing apparatus according to claim 6, wherein
a notification of a processing result of the image processing executed by the image processing apparatus is changed based on the identification information.

10. The control method for an information processing apparatus according to claim 9, wherein
the notification of the processing result of the image processing executed by the image processing apparatus corresponding to the identification information is selected based on information in which the identification information is correlated with the notification.

11. An image processing system comprising:
an information processing apparatus; and
an image processing apparatus, wherein
the information processing apparatus includes
an acquisition section configured to acquire an instruction for image processing and identification information for identifying a user based on an operation input using voice performed by the user,
a storage section configured to store correspondence information in which the identification information is correlated with a setting for the image processing,
an image processing setting controller configured to determine the setting for the image processing corresponding to the identification information acquired by the acquisition section, based on the correspondence information stored in the storage section, and
an image processing request portion configured to request the image processing to the image processing apparatus based on the setting for the image processing determined by the image processing setting controller and the instruction for the image processing acquired by the acquisition section, and
the image processing apparatus includes
a request reception portion configured to receive the request for the image processing from the information processing apparatus, and
an image processing section configured to execute the image processing based on the request received by the request reception portion.

12. The image processing system according to claim 11, wherein
the image processing setting controller changes the setting for the image processing when the instruction acquired by the acquisition section includes information regarding a change of the setting for the image processing.

13. The image processing system according to claim 11, wherein
the image processing setting controller changes the setting for the image processing based on a change history related to the setting for the image processing.

14. The image processing system according to claim 11, wherein
the image processing setting controller causes a notification selection portion to change a notification of a processing result of the image processing executed by the image processing apparatus based on the identification information.

15. The image processing system according to claim 14, wherein
the image processing setting controller causes the notification selection portion to select the notification notification of the processing result of the image processing executed by the image processing apparatus corresponding to the identification information based on aspect information in which the identification information is correlated with the notification.
